(19) United States
(12) Patent Application Publication
(10) Pub. No.: US 2004/0034469 A1
(43) Pub. Date: Feb. 19, 2004

(54) Method and apparatus for managing map data in a memory

(76) Inventor: Myoung-Bog Kim, Anyang-city (KR)

Correspondence Address: Pennie & Edmonds, LLP, 3300 Hillview Avenue, Palo Alto, CA, 94304, US

(21) Appl. No.: 10/331,892

(22) Filed: Dec. 30, 2002

(30) Foreign Application Priority Data
Aug. 16, 2002 (KR) 2002-0048512

(51) Int. Cl. G01C 21/32

(52) U.S. Cl. 701/208; 340/990

(57) ABSTRACT

A method for managing map data stored in a memory for a navigation system of a vehicle includes detecting a current vehicle position, and storing one or more cells corresponding to the current vehicle position in the memory, selected from among navigation map data comprising a plurality of honeycomb-shaped cells. The method also includes determining if a current position cell has changed (the current position cell includes the current vehicle position), and selecting, when the current position cell has changed, cells to discard from cells stored in the memory. Additionally, the method includes discarding the cells selected to be discarded from the memory, and selecting, when the current position cell has changed, cells to upload. Finally, the method includes obtaining cell data for the cells selected to be uploaded, and storing the obtained cell data in the memory.

### FIELD OF THE INVENTION

The present invention relates to a method and apparatus for managing map data in a memory, and more particularly, to a method and apparatus for managing map data stored in a memory for a navigation system of a vehicle.

### BACKGROUND OF THE INVENTION

Navigation systems for displaying a current vehicle position on a map have been widely adopted in vehicles. These navigation systems require map data. The map data for navigation systems are usually recorded in a data storage unit, for example, a CD-ROM or DVD, included in the navigation system. Regional map data is retrieved from the data storage unit as needed. Alternatively, a separate server for providing map data through a network may be used, such that the navigation system can receive regional map data from the server.

A typical navigation system includes a memory for temporarily storing regional map data, for displaying the regional map data, for processing an optimized route, and the like. The regional map data of the current vehicle position is uploaded and stored in this memory. Considering that the map data includes various information such as location and direction of roads, location of buildings, etc., the amount of map data that must be stored in the memory may become very large. Therefore, effective management of the uploading and processing of map data is essential for enhancing operating speed of a navigation system.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In a preferred embodiment, an apparatus for managing map data stored in a memory for a navigation system of a vehicle comprises: a cell data acquisition unit, a memory, and a processing unit. The cell data acquisition unit is for obtaining cell data for one or more cells of the navigation map data, which is comprised of a plurality of honeycomb-shaped cells. The memory is for temporarily storing cell data obtained from the cell data acquisition unit. And, the processing unit is for managing cell data obtained by the cell data acquisition unit and the cell data stored in the memory.

The cell data stored in the memory comprises: cell data of a current position cell including a current vehicle position, and cell data of a plurality of cells adjacent to the current position cell.

In another preferred embodiment, the apparatus of the present invention further includes a vehicle position detector for detecting the current vehicle position. Also, the processing unit executes instructions for: detecting a current vehicle position; storing one or more cells corresponding to the current vehicle position in the memory, selected from among navigation map data comprising a plurality of honeycomb-shaped cells; determining if a current position cell has changed, said current position cell including the current vehicle position; selecting, when the current position cell has changed, cells to be discarded from cells stored in the memory; discarding the cells selected to be discarded from the memory; selecting, when the current position cell has changed, cells to be uploaded; obtaining cell data for the cells selected to be uploaded; and storing the obtained cell data in the memory.

Preferably, the step of selecting cells to be uploaded comprises selecting one or more cells to be uploaded that are adjacent to the current position cell and that are not currently stored in the memory. Also, preferably, the step of selecting cells to be discarded comprises selecting one or more cells to be discarded that are non-adjacent to the current position cell and that are currently stored in the memory.

In another preferred embodiment, the present invention is a method for managing map data stored in a memory for a navigation system of a vehicle. The method comprises: detecting a current vehicle position; storing one or more cells corresponding to the current vehicle position in the memory, selected from among navigation map data comprising a plurality of honeycomb-shaped cells; determining if a current position cell has changed, said current position cell including the current vehicle position; selecting, when the current position cell has changed, cells to discard from cells stored in the memory; discarding the cells selected to be discarded from the memory; selecting, when the current position cell has changed, cells to upload; obtaining cell data for the cells selected to be uploaded; and storing the obtained cell data in the memory.

Preferably, the step of selecting cells to be uploaded comprises selecting one or more cells to be uploaded that are adjacent to the current position cell and that are not currently stored in the memory. Also, preferably, the step of selecting cells to be discarded comprises selecting one or more cells to be discarded that are non-adjacent to the current position cell and that are currently stored in the memory.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of an apparatus for managing map data stored in a memory for a navigation system of a vehicle, according to a preferred embodiment of the present invention;

FIG. 2 illustrates a data structure of regional map data stored in a memory for a navigation system of a vehicle, according to a preferred embodiment of the present invention; and

FIG. 3 is a flowchart of a method for managing map data stored in a memory for a navigation system of a vehicle, according to another preferred embodiment of the present invention.

### DETAILED DESCRIPTION OF THE PREFERRED EMBODIMENTS

A preferred embodiment of the present invention will hereinafter be described in detail with reference to the accompanying drawings.

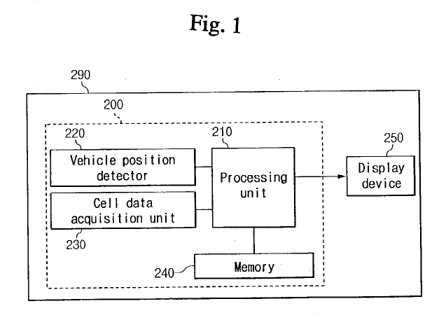

As shown in FIG. 1, an apparatus for managing map data 200 according to a preferred embodiment of the present invention includes: a processing unit 210 for controlling operation of the apparatus; a vehicle position detector 220 for detecting a current vehicle position; a cell data acquisition unit 230 for obtaining cell data from navigation map data of a vehicle; and a memory 240 for temporarily storing cell data obtained by the cell data acquisition unit 230. The apparatus 200 may also include other necessary hardware and software components, as will be understood by persons skilled in the art, to permit the apparatus to communicate with sensors and execute the control function as described herein.

The processing unit 210 receives cell data obtained from the cell data acquisition unit 230, and stores and processes the cell data in the memory 240, such that cell data can be displayed by a display device 250 of a navigation system 290. The processing unit 210 can be implemented by one or more processors activated by predetermined software, and the predetermined software can be programmed to perform each step of a method for managing map data according to a preferred embodiment of the present invention.

The vehicle position detector 220 may be implemented as a receiver for receiving a vehicle position signal from a GPS (Global Positioning System) satellite. In this case, a moving direction of the vehicle can easily be determined based on consecutive vehicle positions.

If the navigation system 290 uses a data storage unit for storing all map data for navigation, the cell data acquisition unit 230 may be implemented as any kind of device that can retrieve cell data from a data storage unit. If the navigation system 290 receives regional map data from a server, the cell data acquisition unit 230 may be implemented as any kind of device that receives the regional map data over a network and extracts cell data therefrom.

The memory 240 is preferably a RAM (Random Access Memory), but it may also be implemented as any kind of semiconductor-based memory. The display device 250 may be implemented as any kind of visual display device, such as a LCD (Liquid Crystal Display).

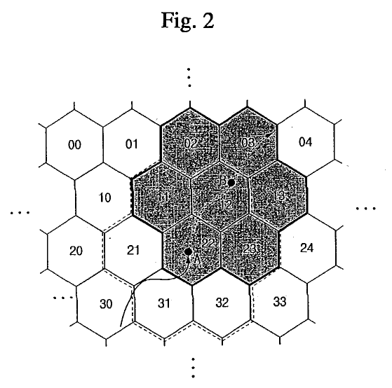

FIG. 2 illustrates a data structure of regional map data stored in the memory of a navigation system of a vehicle, according to a preferred embodiment of the present invention. As shown, a map data structure of a preferred embodiment of the present invention has a honeycomb pattern, wherein each cell of the honeycomb corresponds to a cell of map. Thus, cell data stored in the memory 240 includes data from a specific number of cells selected from the set of cells forming the entire map data set. For example, according to a preferred embodiment, the memory 240 stores cell data of a current position cell that includes a current vehicle position, and cell data of cells adjacent to the current position cell.

Specifically, as shown in FIG. 2, if the vehicle is positioned at point A, cell data for cells 11, 12, 21, 22, 23, 31, and 32 are stored in the memory 240. Thus, less cell data is required to be stored in the memory 240 than in the prior art.

Cell data stored in the memory 240 is updated based on changes of vehicle position. The following description of a method for managing map data, according to a preferred embodiment of the present invention, relates to updating of the cell data.

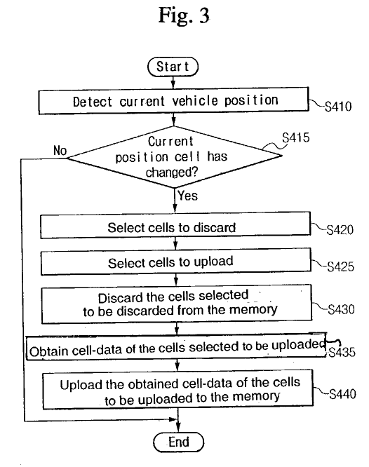

As shown in FIG. 3, a method for managing map data stored in the memory 240 is shown, according to a preferred embodiment of the present invention. The processing unit 210 first receives a signal for a current vehicle position from the vehicle position detector 220 (S410). Then, the processing unit 210 stores one or more cells corresponding to a current vehicle position in the memory (step not shown). The one or more cells are selected from among navigation map data comprising a set of honeycomb-shaped cells. Next, the processing unit determines if a current position cell has changed (S415), based on the received current vehicle position. The current position cell denotes a cell including the current vehicle position.

For example, if the current vehicle position has changed from cell 22 to cell 12, then the processing unit determines that the current cell position has changed. When the current position cell has changed, the processing unit 210 selects cells to discard from cells stored in the memory (S420), and selects cells to upload (S425). When selecting cells to discard, the processing unit 210 selects, as the cells to discard, one or more cells that are non-adjacent to the current position cell and that are currently stored in the memory 240. In selecting the cells to upload, the processing unit 210 selects, as the cells to upload, one or more cells that are adjacent to the current position cell, and that are not currently stored in the memory 240.

For example, when the current vehicle position has moved from cell 22 to cell 12 according to a route shown by a dotted line in FIG. 2, the cells selected to be discarded are cells 21, 31, and 32, and the cells selected to be uploaded are cells 02, 03, and 13. It is preferable that all of the cells 21, 31, and 32 are discarded from the memory 240 and all of the cells 02, 03, and 13 are uploaded in the memory 240. However, alternatively, only some of the identified cells may be selected to be discarded and uploaded based on an expected route of the vehicle.

When the cells to be discarded and cells to be uploaded are selected, the processing unit 210 discards the cells selected to be discarded from the memory 240 (S430), and obtains the cell data of the cells selected to be uploaded (S435). The obtaining of cell-data of the cells to be uploaded may be accomplished by cell data acquisition unit 230. When the cell data of the uploaded cells is obtained, the processing unit 210 uploads the obtained cell data to the memory 240 (S440).

Therefore, when conducting this method according to a preferred embodiment, the size of cell data that must be stored in memory for the navigation system is reduced. Furthermore, the size of cell data that must be deleted from or uploaded to the memory is reduced, and consequently, the data communications caused while following a vehicle route are also reduced. Also, the time for processing cell data stored in the memory is reduced, and the operating speed of the navigation system is enhanced.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims. Throughout this specification and the claims which follow, unless explicitly described to the contrary, the word “comprise” or variations such as “comprises” or “comprising” will be understood to imply the inclusion of stated elements but not the exclusion of any other elements.

What is claimed is:

1. A method for managing map data stored in a memory for a navigation system of a vehicle, the method comprising:
detecting a current vehicle position;
storing one or more cells corresponding to the current vehicle position in the memory, selected from among navigation map data comprising a plurality of honeycomb-shaped cells;
determining if a current position cell has changed, said current position cell including the current vehicle position;
storing in a memory;
selecting, when the current position cell has changed, cells to discard from cells stored in the memory;
discarding the cells selected to be discarded from the memory;
selecting, when the current position cell has changed, cells to upload;
obtaining cell data for the cells selected to be uploaded; and
storing the obtained cell data in the memory.

2. The method of claim 1, wherein the selecting cells to be uploaded comprises selecting one or more cells to be uploaded that are adjacent to the current position cell and that are not currently stored in the memory.

3. The method of claim 1, wherein the selecting cells to be discarded comprises selecting one or more cells to be discarded that are non-adjacent to the current position cell and that are currently stored in the memory.

4. An apparatus for managing map data stored in a memory for a navigation system of a vehicle, the apparatus comprising:
a cell data acquisition unit for obtaining cell data for one or more cells of the navigation map data, the navigation map data being comprised of a plurality of honeycomb-shaped cells;
a memory for temporarily storing cell data obtained from the cell data acquisition unit; and
a processing unit for managing cell data obtained from the cell data acquisition unit and the cell data stored in the memory;
wherein the cell data stored in the memory comprises:
cell data of a current position cell that includes a current vehicle position; and
cell data of a plurality of cells adjacent to the current position cell.

5. The apparatus of claim 4, further comprising a vehicle position detector for detecting the current vehicle position, and wherein the processing unit executes instructions for:
detecting the current vehicle position;
storing one or more cells corresponding to a current vehicle position in the memory, selected from among navigation map data comprising a plurality of honeycomb-shaped cells;
determining if a current position cell has changed, said current position cell including the current vehicle position;
selecting, when the current position cell has changed, cells to be discarded from cells stored in the memory;
discarding the cells selected to be discarded from the memory;
selecting, when the current position cell has changed, cells to upload;
obtaining cell data for the cells selected to be uploaded; and
storing the obtained cell data in the memory.

6. The apparatus of claim 5, wherein the selecting cells to be uploaded comprises selecting one or more cells to be uploaded that are adjacent to the current position cell and that are not currently stored in the memory.

7. The apparatus of claim 5, wherein the selecting cells to be discarded comprises selecting one or more cells to be discarded that are non-adjacent to the current position cell and that are currently stored in the memory.
